(19) United States
(12) Patent Application Publication
(10) Pub. No.: US 2025/0069769 A1
(43) Pub. Date: Feb. 27, 2025

(54) SYSTEM AND METHOD FOR RESOURCE-EFFICIENT INDIVIDUAL QUBIT ADDRESSING

(71) Applicant: THE REGENTS OF THE UNIVERSITY OF CALIFORNIA, Oakland, CA (US)

(72) Inventors: Hartmut Gunter Haeffner, Berkeley, CA (US); Sara Lambert Mouradian, Seattle, WA (US); Eli Magidash, Berkeley, CA (US); Nicole Sarah Greene, Berkeley, CA (US); Zhao Zhang, Beijing (CN)

(21) Appl. No.: 18/727,043

(22) PCT Filed: Jan. 9, 2023
(86) PCT No.: PCT/US2023/010380

§ 371 Date: Jul. 5, 2024

Related U.S. Application Data
(60) Provisional application No. 63/297,289, filed on Jan. 7, 2022.

(51) Int. Cl. G21K 1/00; G02F 1/33; G02F 1/35; G06N 10/40

(52) U.S. Cl. CPC G21K 1/003; G02F 1/33; G02F 1/3526; G06N 10/40

(57) ABSTRACT

In accordance with a method for individually addressing qubits in a set of qubits, a plurality of qubits is provided that each have two internal states representing a unit of quantum information. A transition between the two internal states of each qubit is caused by a two-photon Raman transition. Each of N ones of the qubits in the plurality of qubits are individually addressed using one of N pairs of laser beams, respectively, N being an integer greater than or equal to two. The laser beams in each of the N pairs have a frequency difference equal to a qubit transition frequency that represents a difference in frequency between the two internal states of the qubits. The laser beams in each pair of laser beams operate at different frequencies than the laser beams in every other pair of laser beams.

### CROSS REFERENCE TO RELATED APPLICATION

This application claims the benefit of U.S. Provisional Application Ser. No. 63/297,289, filed Jan. 7, 2022, the contents of which are incorporated herein by reference.

### GOVERNMENT FUNDING

This invention was made with government support under 1818914 awarded by NSF. The government has certain rights in the invention.

### BACKGROUND

Quantum computers have the potential to solve problems exponentially faster than classical computers. A variety of physical systems have been proposed upon which to build quantum computers. The quantum computer analog to a classical binary bit used in classical computers is referred to as a qubit, which is a two-state or two-level quantum-mechanical system, Examples of such systems include ions, neutral atoms and solid state systems. Ion qubits use ions that are trapped and suspended by electromagnetic fields. Solid state qubits may be based, for instance, on optically active defects or quantum dots.

The ions in an ion qubit have internal electronic states that represent the smallest unit of quantum information (i.e., a qubit). The two states in some ion qubits may be represented by two hyperfine or Zeeman sublevels of an individual ion. The two states may be separated by optical frequencies which can be controlled using radiation from a laser. Likewise, solid state qubits generally implement the two-state system in individual electronic or nuclear spin states. For instance, optically addressable quantum defects are point defects in a lattice where a spin degree of freedom is coupled to one or more optical transitions.

The transitions between the two internal states of some qubits that are used as computational states may involve two-photon Raman transitions. In such transitions two photons are used to cause a transition between two states through an intermediate third state, which is typically at a higher energy than the two states of the transition. In these qubits two-photon Raman transitions sometimes may be used to address individual qubits for one of three primary purposes. In particular, the qubits can be optically pumped to one of the two states (preparation or initialization of qubits), manipulated between the two states (single-qubit gate operations), and their internal slates detected by fluorescence upon application of a resonant laser beam (read-out of qubits).

Two-photon Raman transitions are often produced in a qubit by applying two laser beams to the qubit with a frequency difference equal to the qubit transition frequency. One common way to accomplish this when addressing N qubits is to apply N pairs of laser beams to the qubits, with the different laser beam pairs having the same set of frequencies in each pair to thereby apply the same frequency difference to each qubit. That is, a pair of laser beams with frequencies f₁ and f₂ are applied to each qubit, where the frequency difference f₂−f₁ is equal to the qubit transition frequency.

### SUMMARY

In accordance with one aspect of the subject matter described herein, a method and apparatus is provided for individually addressing qubits in a set of qubits. In accordance with the method, a plurality of qubits that each have two internal states representing a unit of quantum information is provided. A transition between the two internal states of each qubit is caused by a two-photon Raman transition. A first selected one of the plurality of qubits is addressed by applying first and second laser beams to the first selected qubit, The first and second laser beams have a frequency difference equal to a qubit transition frequency that represents a difference in frequency between the two internal states of the qubits. A second selected one of the plurality of qubits is addressed by applying third and fourth laser beams to the second selected qubit. The third and fourth laser beams have a frequency difference equal to the qubit transition frequency. The first, second, third and fourth laser beams each have a frequency that is different from one another.

In accordance with one particular aspect of the subject matter described herein, the qubits in the plurality of qubits are selected from the group consisting of trapped ion qubits, neutral atom qubits and solid-state qubits.

In accordance with another particular aspect of the subject matter described herein, the plurality of qubits comprises a linear chain of trapped ions.

In accordance with another particular aspect of the subject matter described herein, the trapped ions are selected from the group consisting of isotopes of Ca, Ba and Yb.

In accordance with another particular aspect of the subject matter described herein, the method further includes directing a laser beam to an acousto-optic deflector (AOD) and controlling the AOD to split the laser beam into at least four laser beams that represent the first, second, third and fourth laser beams.

In accordance with another particular aspect of the subject matter described herein, applying the first and second beams to the first selected qubit further includes selectively directing the first, second, third and fourth laser beams from the AOD to imaging optics that focus the first and second laser beams onto the first selected qubit and the third and fourth laser beams onto the second selected qubit.

In accordance with another particular aspect of the subject matter described herein, the imaging optics include a beam expander and an objective lens arrangement.

In accordance with another particular aspect of the subject matter described herein, controlling the OAD includes controlling the AOD to selectively adjust the amplitude, phase and/or frequency of the first, second, third and fourth laser beams.

In accordance with another particular aspect of the subject matter described herein, controlling the OAD is performed using a radio-frequency (RF) controller.

In accordance with yet another particular aspect of the subject matter described herein, a method is provided for individually addressing qubits in a set of qubits. In accordance with the method, a plurality of qubits is provided that each have two internal states representing a unit of quantum information. A transition between the two internal states of each qubit is caused by a two-photon Raman transition. Each of N ones of the qubits in the plurality of qubits are individually addressed using one of N pairs of laser beams, respectively, N being an integer greater than or equal to two. The laser beams in each of the N pairs have a frequency difference equal to a qubit transition frequency that represents a difference in frequency between the two internal states of the qubits. The laser beams in each pair of laser beams operate at different frequencies than the laser beams in every other pair of laser beams.

In accordance with another particular aspect of the subject matter described herein, a quantum state controller is provided for individually addressing qubits in a set of qubits. The quantum state controller includes a quantum system, one or more acousto-optic deflectors (OADs), imaging optics and an electronic controller. The quantum system includes a plurality of qubits that each have two internal states representing a unit of quantum information. A transition between the two internal states of each qubit being caused by a two-photon Raman transition. The one or more OADs are configured to (i) receive at least one laser beam, (ii) split each of the laser beams into at least two pairs of laser beams, the laser beams in each pair having a frequency difference equal to a qubit transition frequency that represents a difference in frequency between the two internal states of the qubits, and (iii) selectively direct each of the laser beam pairs in a direction that causes each of the laser beam pairs to be directed onto a selected one of the qubits. The imaging optics are configured to receive the pairs of laser beams from the one or more AODs and respectively direct the pairs of laser beams onto the selected ones of the qubits. The electronic controller is configured to control operation of the one or more AODs such that the laser beam pairs are respectively directed onto the selected ones of the qubits.

In accordance with another particular aspect of the subject matter described herein, the one or more AODS includes first and second AODs each providing one of the laser beams in each of the pairs of laser beams.

In accordance with another particular aspect of the subject matter described herein, the one or more AODS includes a single AOD providing each of the laser beams in each of the pairs of laser beams.

In accordance with another particular aspect of the subject matter described herein, the qubits in the plurality of qubits are selected from the group consisting of trapped ion qubits, neutral atom qubits and solid-state qubits.

In accordance with another particular aspect of the subject matter described herein, the plurality of qubits comprises a linear chain of trapped ions.

In accordance with another particular aspect of the subject matter described herein, the trapped ions are selected from the group consisting of isotopes of Ca, Ba and Yb.

In accordance with another particular aspect of the subject matter described herein, the imaging optics include a beam expander and an objective lens arrangement.

In accordance with another particular aspect of the subject matter described herein, the electronic controller is configured to control the AOD to selectively adjust the amplitude, phase and/or frequency of the at least one laser beam.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a simplified schematic diagram of one example of a quantum state controller.

FIG. 2 shows a transition between two Zeeman sublevels in a ⁴⁰Ca ion that is caused by a two-photon Raman transition.

FIG. 3 shows a simplified schematic diagram of a quantum state controller similar to the controller shown in FIG. 1, except that in FIG. 3 the qubit system is depicted as trapped ions located in a linear trap within a vacuum chamber.

FIG. 4 is a simplified schematic diagram of the quantum state controller in which the two addressing beams intersect on the qubits at an angle 0.

FIG. 5 is a simplified schematic diagram of the quantum state controller in which the two addressing beams are co-propagating with respect to one another.

FIG. 6 is a simplified schematic diagram of one example of a quantum processor in which the quantum state controller described herein may be employed.

### DETAILED DESCRIPTION

The conventional approach described above for addressing qubits results in systems that are bulky and inefficient in both space and overall optical power. Moreover, changes in the qubit number or layout necessitates significant changes to the optical arrangement and as a consequence cannot be performed on-the-fly.

In contrast to the conventional approach described above, systems and techniques are described herein in which a quantum state controller applies a different laser beam pair to each qubit, where the frequencies of the laser beams in each pair differ from the frequencies of the laser beams in every other pair. Nevertheless, within each pair, the frequency difference between the two beams remains equal to the qubit transition frequency. That is, for a system of N qubits, N laser beam pairs are applied to address the individual qubits, with the first pair having frequencies f₁ and f₁+Δ, the second pair having frequencies f₂ and f₂+Δ and so on, with a pair of frequencies f_{N} and f_{N}+Δ being applied to the N^{th} qubit, where Δ is equal to the qubit transition frequency.

FIG. 1 shows a simplified schematic diagram of one example of a quantum state controller 100 that may be employed to individually address the qubits 120 in a set of N qubits that undergo a transition between their two computational states using a two-photon Raman process. In this example, a single laser beam generated by a laser source (not shown) is provided to an acousto-optic modulator or deflector (AOD) 105 that produces one of the addressing laser beams in each of the laser beam pairs that are applied to the qubits. The AOD 105 is able to control the amplitude, frequency and phase of the addressing beams under the control of an RF generator 130. In particular, the AOD 105 splits an incoming laser beam (e.g., a single frequency laser beam) into N qubit addressing beams with frequencies f₁, f₂, . . . f_{N}, which are each emitted from the AOD 105 at different angles corresponding to their respective diffraction orders. The addressing beams are then directed to imaging optics that focus each addressing beam onto a different one of the qubits. In the particular example shown in FIG. 1 the imaging optics include a beam expander 110 for achieving high resolution and an objective 115 for focusing the individual addressing beams onto each qubit.

As shown in FIG. 1, the same configuration that is described above for providing one of the addressing beams to each qubit is mirrored for the second addressing beam that is also provided to each qubit. While the initial laser beam that is provided to each of the two AODs may be supplied by different lasers sources, it typically will be advantageous to use a single laser source to supply the beams to both AODs so that any noise that arises becomes common mode. Likewise, if the system is arranged so that the path length to each qubit is the same, most fluctuations will be common mode. The initial laser beam input to the AOD may have any suitable shape or profile, such as Gaussian (as in a typical laser) or flat top (to increase resolution and limit cross-talk), for example.

As explained above, the quantum state controller described herein may be used to individually address any type of qubit that undergoes a transition between their two computational states using a two-photon Raman process, including trapped ions, trapped neutral atoms, and solid state qubits such as solid state defect centers and quantum dots. Such qubits will generally require optical wavelengths between 350 nm and 1800 nm, though more generally any suitable optical wavelengths may be employed. In the case of qubits implemented using trapped ions, the qubit computation states may be encoded in two Zeeman sublevels, two hyperfine sublevels or two optical levels. Moreover, the systems and techniques described herein may be applied to qudits that encode three or more internal states, such as three Zeeman, hyperfine or optical sublevels in the case of trapped ions.

In general, the imaging optics that are employed may use any suitable combination of optical elements to individually focus the addressable beams onto the qubits, including without limitation, various refractive and/or reflective optics. For instance, in some implementations only an objective may be required without use of the beam expander shown in FIG. 1. In yet other implementations, for example, a spatial light modulator and/or gratings may be employed instead of the OAD. Of course, a wide variety of other optical arrangements may be employed as well.

A number of advantages arise from use of the qubit addressing arrangement described herein. For example, the system is re-configurable simply by changing the RF control fields to thereby rapidly and easily change the number of qubits that may be individually addressed in a sequential or simultaneous manner. This reconfiguration can be accomplished on sub-microsecond timescales. Moreover, the laser power can be re-distributed among the qubits on the fly and can be reconfigured to accommodate different spatial qubit layouts and arbitrary and mutable qubit spacings. The amount of power applied to each qubit is limited by the number of gates that need to be addressed simultaneously (P=1/N_{gates}). In conventional systems, the amount of power cannot be easily changed and is limited by the number of qubits (P=1/N_{qubits}<1/N_{gates}). Also, conventional systems are limited to pre-determined qubit spacings and often cannot match the actual spacings of the qubits.

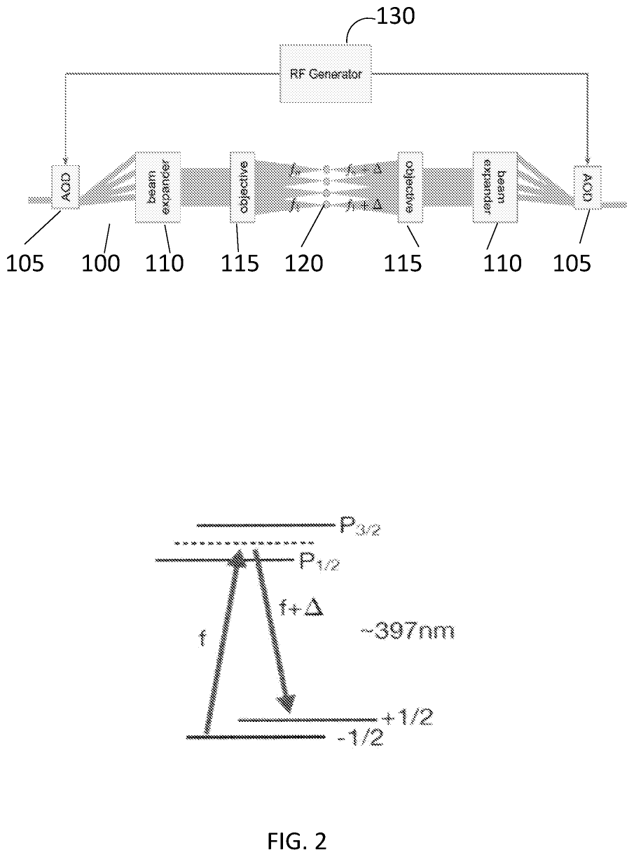

One particular example of a qubit system that may be used in connection with the quantum state controller described herein, which is presented by way of illustration only and not as a limitation on the systems and techniques described herein, is a linear array of ⁴⁰Ca ions, where the qubit is encoded in the populations of two Zeeman sublevels, as illustrated in FIG. 2. The manipulation of individual ions may be used to drive simultaneous single and multi-qubit gates on a linear array of such ions. To drive single qubit gates, a qubit transition frequency of about 10 MHz may be employed, which corresponds to the B-field splitting between the two Zeeman sublevels. To drive multi-qubit gates, a laser beam frequency of about 1 MHz may be employed, which corresponds to the motional mode frequency.

In addition to ⁴⁰Ca, other Ca isotopes that may be used in connection with trapped ion qubits includes ⁴³Ca and ⁴⁸Ca. In other embodiments of a trapped ion systems, other isotopes that may be employed include, without limitation, ¹³³Ba, ¹³⁸Ba and various Yb isotopes.

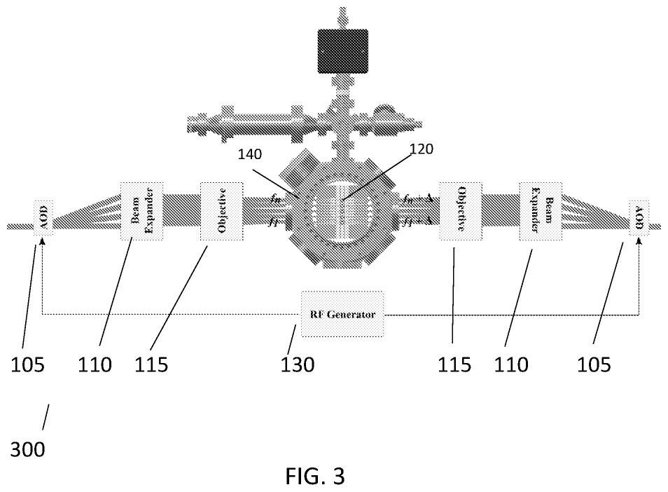

FIG. 3 shows a simplified schematic diagram of a quantum state controller 300 similar to the controller shown in FIG. 1, except that in FIG. 3 the qubit system is depicted as trapped ions that are arranged in a linear trap within a vacuum chamber 140. In FIGS. 1 and 3, like elements are denoted by like reference numerals.

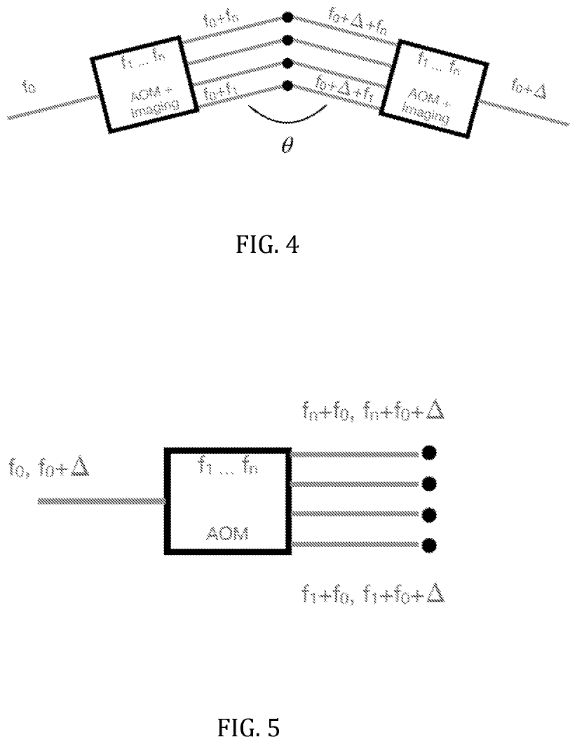

In the embodiment of the invention shown in FIG. 1 the addressing beams are directed onto the qubits in a counter-propagating manner in which the beams are incident from directions 180° apart from another. More generally, however, the addressing beams may be directed onto the qubits so that they intersect with at any desired angle between them. A simplified schematic diagram of such an arrangement in shown in FIG. 4, in which the two beams intersect on the qubits at an angle θ. Such an arrangement may advantageously allow certain qubit operations to be performed which cannot be readily performed using the counter-propagating arrangements shown in FIGS. 1 and 3.

In yet another alternative embodiment, the laser beams directed onto the qubits may be co-propagating with respect to one another. An example of such an arrangement is shown in FIG. 5, in which the two laser beams, one with a frequency f₀ and the other with a frequency f₀+Δ, are incident upon a single OAD and a common set of imaging optics so that the resulting laser beams are directed onto the qubits from a common direction.

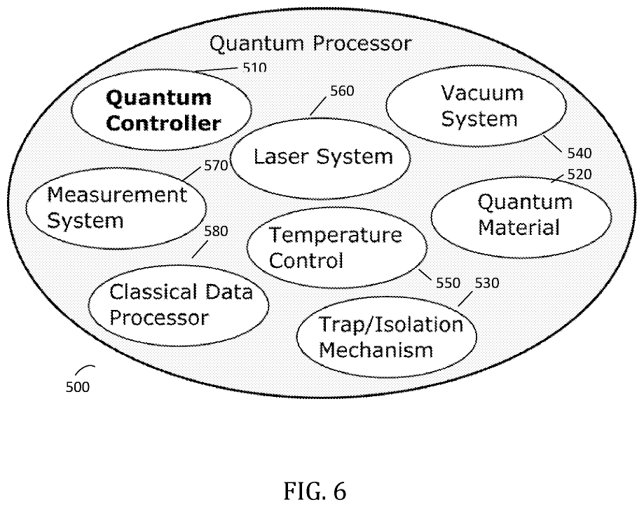

FIG. 6 is a simplified schematic diagram of one example of a quantum processor 500 in which the quantum controller described herein may be employed. The quantum processor may be employed in a wide range of devices and used in a wide variety of applications including, by way of example, a quantum sensor, a quantum simulator, an atomic clock and a quantum network node. Illustrative applications may include gate-based quantum computing and qudit control.

The illustrative quantum processor 500 shown in FIG. 6 can perform quantum computational tasks by executing quantum algorithms. The quantum processor 500 can perform quantum computation by storing and manipulating information within individual quantum states of quantum material, which in this particular example, but not as a limitation on the systems and systems and techniques described herein, are trapped ions.

As shown, the quantum processor 500 may include the quantum controller 510, the quantum material 520 and a mechanism 530 for trapping and isolating the trapped ions that are used as the quantum material in this particular example. Also shown are ancillary components used in connection with the trap/isolation mechanism 530 such as a vacuum system 540, a temperature controller 550, and optical components such as the depicted laser system 560 used in connection with the quantum controller 510 described above. The quantum processor 500 also includes a measurement system 570 as well as a classical data processor 580 for controlling the operation of the quantum processor 500. Of course, those of ordinary skill in the art will recognize that the quantum processor 500 may include additional or different features, and the components of the quantum processor 500 may operate as described or in another manner.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method for individually addressing qubits in a set of qubits, comprising:
providing a plurality of qubits that each have two internal states representing a unit of quantum information, a transition between the two internal states of each qubit being caused by a two-photon Raman transition;
addressing a first selected one of the plurality of qubits by applying first and second laser beams to the first selected qubit, the first and second laser beams having a frequency difference equal to a qubit transition frequency that represents a difference in frequency between the two internal states of the qubits; and
addressing a second selected one of the plurality of qubits by applying third and fourth laser beams to the second selected qubit, the third and fourth laser beams having a frequency difference equal to the qubit transition frequency, the first, second, third and fourth laser beams each having a frequency that is different from one another.

2. The method of claim 1 wherein the qubits in the plurality of qubits are selected from the group consisting of trapped ion qubits, neutral atom qubits and solid-state qubits.

3. The method of claim 2 wherein the plurality of qubits comprises a linear chain of trapped ions.

4. The method of claim 3 wherein the trapped ions are selected from the group consisting of isotopes of Ca, Ba and Yb.

5. The method of claim 1 further comprising directing a laser beam to an acousto-optic deflector (AOD) and controlling the AOD to split the laser beam into at least four laser beams that represent the first, second, third and fourth laser beams.

6. The method of claim 1 wherein applying the first and second beams to the first selected qubit further comprises selectively directing the first, second, third and fourth laser beams from the AOD to imaging optics that focus the first and second laser beams onto the first selected qubit and the third and fourth laser beams onto the second selected qubit.

7. The method of claim 6 wherein the imaging optics include a beam expander and an objective lens arrangement.

8. The method of claim 1 wherein controlling the OAD includes controlling the AOD to selectively adjust the amplitude, phase and/or frequency of the first, second, third and fourth laser beams.

9. The method of claim 1 wherein controlling the OAD is performed using a radio-frequency (RF) controller.

10. A method for individually addressing qubits in a set of qubits, comprising:
providing a plurality of qubits that each have two internal states representing a unit of quantum information, a transition between the two internal states of each qubit being caused by a two-photon Raman transition; and
individually addressing each of N ones of the qubits in the plurality of qubits using one of N pairs of laser beams, respectively, N being an integer greater than or equal to two, the laser beams in each of the N pairs having a frequency difference equal to a qubit transition frequency that represents a difference in frequency between the two internal states of the qubits, wherein the laser beams in each pair of laser beams operate at different frequencies than the laser beams in every other pair of laser beams.

11. A quantum state controller for individually addressing qubits in a set of qubits, comprising:
a quantum system that includes a plurality of qubits that each have two internal states representing a unit of quantum information, a transition between the two internal states of each qubit being caused by a two-photon Raman transition;
one or more acousto-optic deflectors (OADs) configured to (i) receive at least one laser beam, (ii) split each of the laser beams into at least two pairs of laser beams, the laser beams in each pair having a frequency difference equal to a qubit transition frequency that represents a difference in frequency between the two internal states of the qubits, and (iii) selectively direct each of the laser beam pairs in a direction that causes each of the laser beam pairs to be directed onto a selected one of the qubits;
imaging optics configured to receive the pairs of laser beams from the one or more AODs and respectively direct the pairs of laser beams onto the selected ones of the qubits; and
an electronic controller configured to control operation of the one or more AODs such that the laser beam pairs are respectively directed onto the selected ones of the qubits.

12. The quantum state controller of claim 11 wherein the one or more AODS includes first and second AODs each providing one of the laser beams in each of the pairs of laser beams.

13. The quantum state controller of claim 11 wherein the one or more AODS includes a single AOD providing each of the laser beams in each of the pairs of laser beams.

14. The quantum state controller of claim 11 wherein the qubits in the plurality of qubits are selected from the group consisting of trapped ion qubits, neutral atom qubits and solid-state qubits.

15. The quantum state controller of claim 14 wherein the plurality of qubits comprises a linear chain of trapped ions.

16. The quantum state controller of claim 15 wherein the trapped ions are selected from the group consisting of isotopes of Ca, Ba and Yb.

17. The quantum state controller of claim 11 wherein the imaging optics include a beam expander and an objective lens arrangement.

18. The quantum state controller of claim 11 wherein the electronic controller is configured to control the AOD to selectively adjust the amplitude, phase and/or frequency of the at least one laser beam.
